(19) United States
(12) Patent Application Publication
(10) Pub. No.: US 2024/0374075 A1
(43) Pub. Date: Nov. 14, 2024

(54) APPARATUS FOR PREPARING BREWED BEVERAGES ON DEMAND

(71) Applicant: Appliance Innovation, Inc., Richardson, TX (US)

(72) Inventors: Philip R. McKee, Dallas, TX (US); Lee VanLanen, McKinney, TX (US); Scott Smith, Richardson, TX (US); Andrew Podevels, Wauwatosa, WI (US)

(21) Appl. No.: 18/783,336

(22) Filed: Jul. 24, 2024

Related U.S. Application Data
(63) Continuation-in-part of application No. 18/099,485, filed on Jan. 20, 2023.

(51) Int. Cl. A47J 31/40; A47J 31/41; A47J 31/52; A47J 31/60

(52) U.S. Cl. CPC A47J 31/402; A47J 31/41; A47J 31/52; A47J 31/60

(57) ABSTRACT

An apparatus for preparing brewed beverages on demand is disclosed. After a beverage concentrate is brewed using hot water, the temperature of the beverage concentrate is reduced from a first temperature to a second temperature upon the brewing of the beverage concentrate. The temperature of the beverage concentrate is further reduced from the second temperature to a third temperature. After receiving a specific beverage order from a user via a touch screen, a tea-serving manifold combines the beverage concentrate from the storage receptacle, hot water and tap water to generate a specific beverage to fulfill the specific beverage order for the user, and the specific beverage is dispensed to the user via a delivery nozzle.

### CROSS-REFERENCE TO RELATED APPLICATIONS

The present application claims the priority of U.S. patent application Ser. No. 18/099,485, filed on Jan. 20, 2023, the contents of which are incorporated herein by reference.

### TECHNICAL FIELD

The present application relates to beverage brewing machines in general, and, in particular, to an apparatus for preparing brewed beverages on demand.

### BACKGROUND

Convenience stores commonly include multiple tea brewing stations, each of which can brew and dispense a different flavor of tea for their customers. Each tea brewing station may include two tea urns with one containing an unsweetened version of a tea and the other containing a sweetened version of the same tea.

For each tea urn, hot water is poured over a tea bag to produce a tea concentrate having a temperature of about 200° F. This tea concentrate is then diluted by adding tap water having a temperature of about 70° F. If the diluted tea is to be sweetened, a sweetener can be added along with the tap water. The initial temperature of the diluted tea in each tea urn is about 100° F., and the diluted tea eventually cools down to room temperature where it is held to be drawn from the tea urn by a customer.

There are many problems associated with this type of conventional tea brewing stations. First, the temperature of the diluted tea drawn by the customers from the tea urn into a cup containing ice may vary drastically, depending on when the tea was brewed. For example, if the customer draws the tea during the brewing process, the tea will have a much higher temperature than when the tea is drawn after the diluted tea has cooled down. This means that the ice in the cup will melt differently depending on the temperature of the diluted tea when it is drawn into the cup. Also, the consistency of the diluted tea will vary depending on when it is drawn into the cup because the tea solids (such as tea particles) will tend to settle at the bottom of the tea urn over time.

Second, the diluted tea maintains its “fresh brew” quality for only about 90 minutes, and then it begins to deteriorate due to microbial growth occurring in the diluted tea. The diluted tea starts to show signs of degradation in quality at about three hours after brewing and the degradation continues until the diluted tea must be discarded due to unacceptable quality after about six to eight hours. Thus, conventional tea brewing stations sustain a high level of waste, especially when sweet tea has to be discarded because sweet tea is more expensive due to the cost of sweetener.

Third, when the diluted tea in a tea urn is discarded due to unacceptable quality, or when the tea urn is emptied by customers, an employee of the convenience store must brew a fresh batch of tea by placing a fresh tea bag in the brew station and initiating the brewing process. However, the convenience store employee may not immediately notice the need to brew a fresh batch of tea or may be busy doing other work. As a result, fresh batches of tea may not be brewed on time.

Finally, tea urns need to be cleaned daily. Thus, the convenience store employee has to remove all the tea urns from the tea brewing stations and then return them back to their respective locations after cleaning. The cleaning process is time-consuming and tedious. If the cleaning does not get done or not done properly, dirty tea urns will degrade the quality of the diluted tea.

Consequently, it would be desirable to provide an improved commercial tea brewing and dispensing system that can overcome the above-mentioned problems.

### SUMMARY OF THE INVENTION

In accordance with a preferred embodiment, an apparatus for preparing brewed beverages on demand includes a touch screen, a controller, and multiple storage receptacles connected to a tea-serving manifold via pumps and tubes. Various beverage concentrates are stored in the storage receptacles that are located within a refrigerator to keep the beverage concentrates cool in order to reduce microbial growth. After receiving a specific beverage order from a user via the touch screen, the controller activates one of the pumps to draw a beverage concentrate stored within one of the storage receptacles, with the beverage concentrate corresponding to the specific beverage order. The tea-serving manifold mixes the beverage concentrate from the storage receptacle with an appropriate amount of water to generate a specific beverage to fulfill the specific beverage order, and the specific beverage can be dispensed via a delivery nozzle.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 shows a front view of an apparatus for preparing brewed beverages on demand, in accordance with one embodiment of the present invention;

FIG. 2 shows a top view of the apparatus from FIG. 1;

FIG. 3 shows a side view of an upper portion of the apparatus from FIG. 1;

FIG. 4 shows the plumbing connections of the apparatus from FIG. 1; and

FIG. 5 shows an order entry screen of the apparatus from FIG. 1, in accordance with one embodiment of the present invention.

### DETAILED DESCRIPTION OF A PREFERRED EMBODIMENT

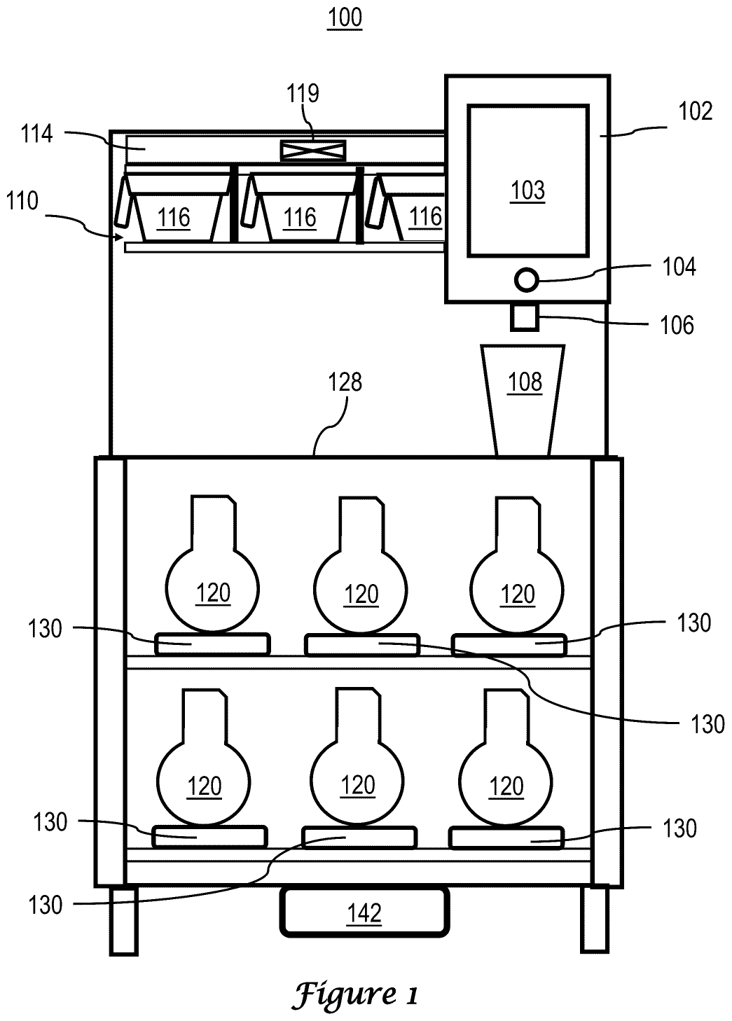

Referring now to the drawings and in particular to FIG. 1, there is illustrated a front view of an apparatus for preparing brewed beverages for a customer on demand, in accordance with one embodiment of the present invention. As shown, an apparatus 100 includes a brew compartment 110 for brewing various types of tea that will be dispensed by apparatus 100. Brew compartment 110 includes a rotating tray 114 having multiple brew baskets 116 located thereon. Each of brew baskets 116 can hold a tea bag for brewing tea concentrate.

Apparatus 100 also includes multiple storage receptacles 120 for receiving and holding tea concentrates that are brewed in brew baskets 116. Each of brew baskets 116 can be in fluid communication with any one of storage receptacles 120 via various pumps and tubing (not shown). In other words, multiple brew baskets 116 are in fluid communication with any one single storage receptacle 120. Each storage receptacle 120 sits on a dedicated load cell 130 within a refrigerator 128. Each storage receptacle 120 includes a motor and a stirrer (not shown) for stirring the tea concentrate periodically while it is being held within storage receptacle 120.

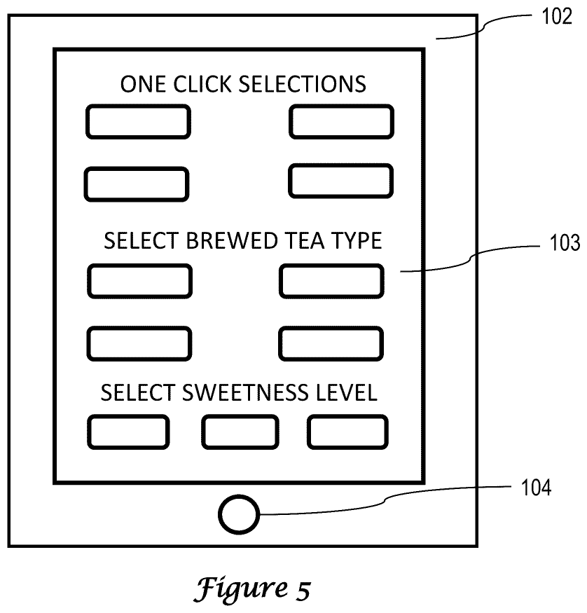

Apparatus 100 further includes a display 102 that displays an order entry screen 103 where a customer can order a customized tea beverage. Display 102 is preferably implemented using a touch-screen display, but it can also be implemented using any other suitable means. One example of order entry screen 103 is illustrated in FIG. 5. After a tea beverage has been ordered via order entry screen 103, a customer can press a button 104 to dispense the tea beverage through a delivery nozzle 106 into a cup 108 that the customer has placed beneath delivery nozzle 106.

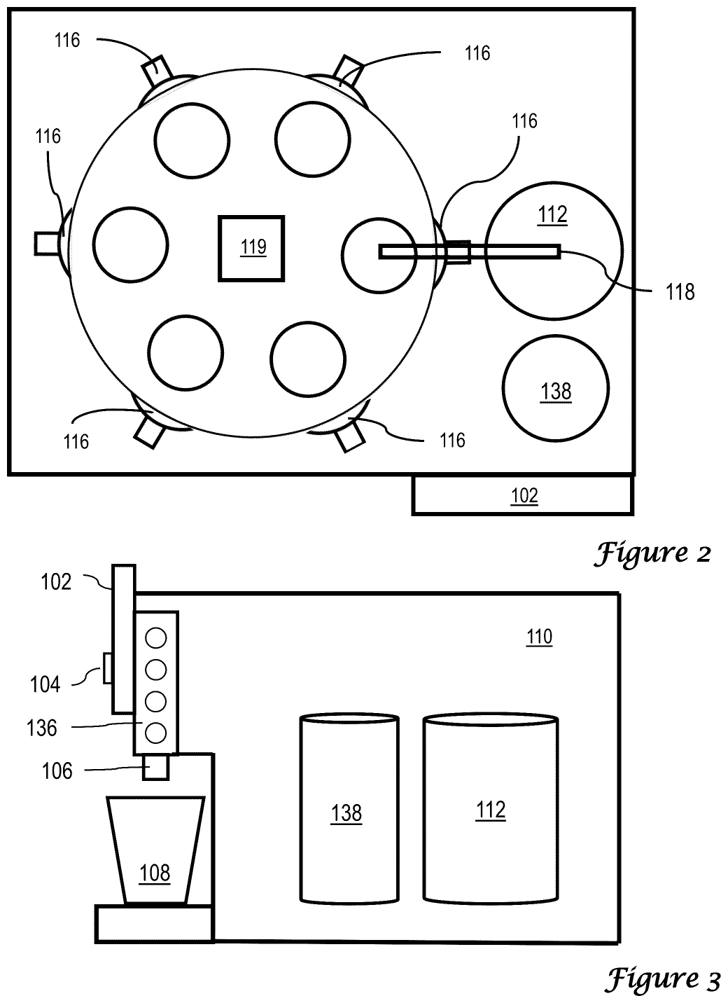

As shown in FIG. 2, rotating tray 114 has six brew baskets 116 such that apparatus 100 is capable of brewing six different types of tea. However, the number of brew baskets 116 is not necessarily equal to the number of types of tea that apparatus 100 may be configured to offer. For example, the number of types of tea that apparatus 100 is configured to offer can be less than the number of brew baskets 116. Rotating tray 114 may include a fan 119 located on a top portion thereof, above brew baskets 116. Fan 119 pushes the aromas of the tea bags and/or brewing teas from brew baskets 116 to the front of apparatus 100.

Brew compartment 110 also includes a hot water tank 112, as shown in FIG. 3, that provides a source of hot water for brewing. In order to brew a tea concentrate, a tea bag (not shown) for a particular type of tea is placed into one of brew baskets 116, and hot water from hot water tank 112 is poured into brew basket 116 through a hot water conduit 118, as shown in FIG. 2, and comes in contact with the tea bag to brew the tea concentrate.

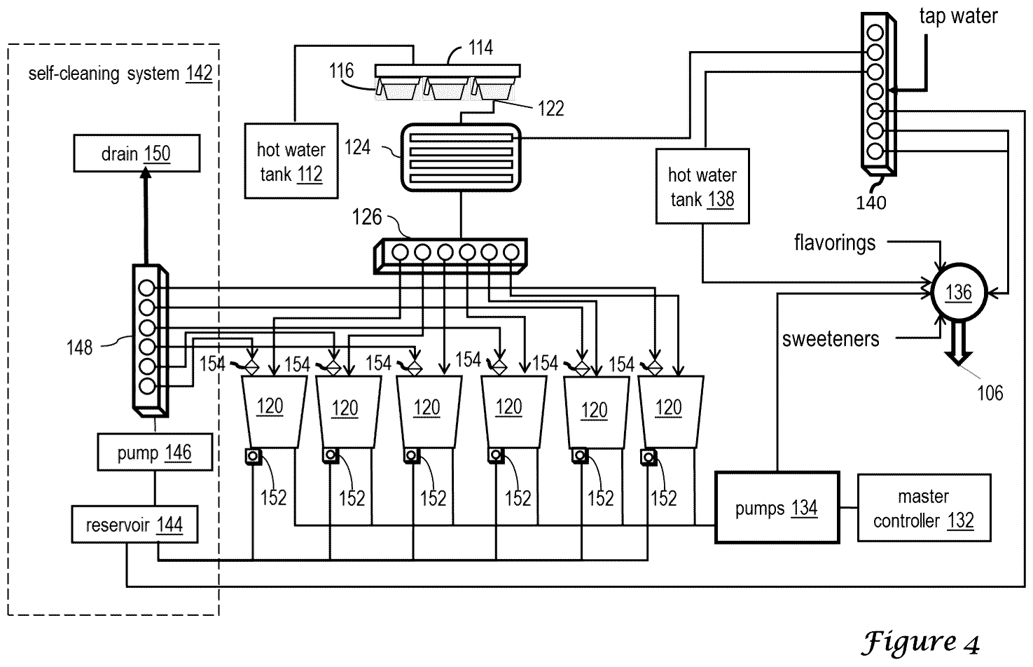

During operation, each of brew baskets 116 is in fluid communication with only one of storage receptacles 120 at a time through a fluid diverter 126, as shown in FIG. 4. The freshly brewed hot tea concentrate exits one of brew baskets 116 through an exit nozzle 122 at a temperature of about 200° F. and proceeds to a heat exchanger 124, where the hot tea concentrate is immediately cooled to a temperature of about 70° F. Heat exchanger 124 is preferably a counter-flow heat exchanger, but heat exchanger 124 can also be implemented using any other suitable means.

For conventional tea brewing and delivery systems, the temperature of the tea in a tea urn typically varies between about 100° F. and about 80° F., depending on when the tea was brewed, and microbial growth tends to occur rapidly in the tea within this temperature range. In contrast, by immediately cooling the freshly brewed hot tea concentrate from about 200° F. to about 70° F. using heat exchanger 124, the microbial growth in the tea in apparatus 100 is significantly reduced from the outset.

After exiting heat exchanger 124, the cooled tea concentrate is directed to one of storage receptacles 120 by fluid diverter 126. As mentioned previously, storage receptacles 120 are located in refrigerator 128 so that the cooled tea concentrate is further cooled while being held within storage receptacles 120. The tea concentrate has a temperature of about 70° F. when it enters storage receptacles 120. Within about 90 minutes after entering storage receptacles 120, the temperature of the tea concentrate drops to about 50° F. The temperature of the tea concentrate eventually drops to about 40° F. within four hours after entering storage receptacles 120. As a result of the immediate cooling of the freshly brewed tea concentrate in heat exchanger 124 and the subsequent cooling of the tea concentrate in refrigerated storage receptacles 120, the tea concentrate can remain in storage receptacles 120 for about one week or longer without experiencing a degradation in quality.

For the present embodiment, apparatus 100 is configured to brew six different types of tea, and refrigerator 128 can hold six storage receptacles 120, as shown in FIG. 1. Depending on the preferences of food-service operators, apparatus 100 may be configured to offer fewer or more than six types of brewed tea, in which case refrigerator 128 would hold a corresponding number of storage receptacles 120.

As mentioned above, each storage receptacle 120 sits on a dedicated load cell 130 within refrigerator 128. Load cells 130 are monitored by a master controller 132, as shown in FIG. 4. When the weight of the tea concentrate in storage receptacle 120 has dropped below a predetermined weight, master controller 132 can determine that the tea concentrate in storage receptacle 120 must be replenished. Alternatively, each storage receptacle 120 may include a level sensor that is used to detect the level of tea concentrate within. The levels of tea concentrate remaining in storage receptacles 120 can be sensed by sensors such as resistive probes, optical sensors, and float switches. Each level sensor can be monitored by master controller 132.

After a determination that the level of tea concentrate within storage receptacle 120 has dropped below a predetermined level, master controller 132 then initiates automated brewing of the type of tea that must be brewed. Specifically, master controller 132 instructs a motor (not shown) to rotate rotating tray 114 such that brew basket 116 containing a tea bag with the type of tea that must be brewed is in position to receive hot water from brew hot water tank 112 through hot water conduit 118. Master controller 132 then instructs hot water tank 112 to provide hot water to brew basket 116 through hot water conduit 118 to brew the tea. Finally, master controller 132 also instructs fluid diverter 126 to rotate to a proper position to direct the tea concentrate to the appropriate storage receptacle 120 after it exits heat exchanger 124.

After a customer has placed a specific tea order via order entry screen 103, as shown in FIG. 5, the tea concentrate corresponding to the specific tea order placed by the customer is pumped from its storage receptacle 120 by one of pumps 134 that associates with that storage receptacle 120. For the current embodiment, pumps 134 are peristaltic pumps, but pumps 134 can also be implemented using any other suitable means.

Pump 134 pumps the tea concentrate to a tea-serving manifold 136 that serves as a mixing vessel where the tea concentrate is mixed with hot water from a second hot water tank 138 and with tap water from a tap water manifold 140 to provide a diluted tea beverage. The tap water from tap water manifold 140 may first be chilled to a temperature below the temperature of the water supplied to tap water manifold 140 and the chilled water is mixed with the tea concentrate and the hot water from second hot water tank 138 within tea-serving manifold 136. If possible, the use of chilled water is preferable so that the dispensed tea beverage will have a lower temperature and thereby will melt less ice in cup 108.

During the ordering process, the customer may select a sweetness level for the tea beverage. Although not shown in FIG. 5, other order entry screens allow the customer to select various additives (such as flavorings or particular types of sweeteners) that can be added to the tea. Commonly preferred combinations of teas, sweeteners, and flavorings can be offered together as “One Click Selections,” as depicted on order entry screen 103 in FIG. 5. Any sweeteners and/or flavorings that the customer selected to include in its tea beverage are mixed with the diluted tea beverage in tea-serving manifold 136, prior to the dispensing of the completed tea beverage through delivery nozzle 106.

The temperature of the hot water provided by second hot water tank 138 is about 200° F. and the tea concentrate, hot water, and tap water (or chilled water) are mixed within tea-serving manifold 136 in accordance with the following mixing ratio: about one part tea concentrate to about two parts hot water to about three parts tap water (or chilled water). It has been found that the ratio of hot water to tea concentrate is dependent upon the temperature of the hot water. Specifically, for a hot water temperature that is in the range of about 180° F. to about 200° F., the use of about two parts hot water in the mixing ratio eliminates a cloudy appearance of the diluted tea beverage that occurs when about one part tea concentrate is mixed with about five parts tap water (or chilled water). It has also been found that a mixing ratio of about one part tea concentrate to about one part hot water to about four parts tap water (or chilled water) will also eliminate a cloudy appearance of the diluted tea beverage if the hot water is at a boiling temperature (i.e., about 212° F.). The cloudy appearance of the diluted tea beverage can also be eliminated using a mixing ratio of about one part tea concentrate to about five parts tap water (or chilled water) if the tea concentrate is heated at some point between refrigerated storage receptacle 120 and tea serving manifold 136 to a temperature that eliminates the cloudiness. Such heating can be provided by pumping the tea concentrate through a heat exchanger or by using a microwave.

The amount of tap water (or chilled water) in the above-mentioned mixing ratio may vary depending on the sweetener level, the flavorings, and the concentration of the tea concentrate for the tea beverage that the customer has ordered. For example, if the tea beverage being dispensed by apparatus 100 includes a sweetener, the sweetener also dilutes the tea beverage. Accordingly, if the tea beverage includes a liquid sweetener (and, potentially, flavorings), the amount of tap water (or chilled water) will be reduced (i.e., will be less than about three parts for every part of the tea concentrate) to keep the tea concentration of the tea beverage roughly constant.

In general, the volume of tap water (or chilled water) will be reduced by an amount that is about equal to the volume of any liquid sweetener and any liquid flavorings that are being added to the tea beverage. However, the settings of apparatus 100 can be fine-tuned to control the amount of tap water (or chilled water) and the amount of tea concentrate provided to the tea serving manifold 136 for each sweetness level available for the tea beverage.

Alternatively, apparatus 100 can be configured to also dispense a hot tea beverage. In that case, the amount of tap water (or chilled water) that is mixed with the tea concentrate and the hot water in tea serving manifold 136 may be significantly reduced or even eliminated. For instance, hot tea may be dispensed at a mixing ratio of one part tea concentrate to five parts hot water. The settings of apparatus 100 can be adjusted to customize the dispense temperature of the hot tea. In that case, some of the hot water will be substituted with an amount of tap water (or chilled water) sufficient to provide the desired dispense temperature for the hot tea.

In the present embodiment, apparatus 100 includes a self-cleaning system 142. Referring to FIG. 4, self-cleaning system 142 includes a reservoir 144, a self-clean pump 146, and a self-clean manifold 148. The self-cleaning process is initiated by pressing a “Clean” button on a system screen that is displayed on display 102. Master controller 132 then causes display 102 to prompt an employee of a convenience store to place a cleaning aid, such as a cleaning tablet, into one or more of brew baskets 116. It should be noted that the cleaning tablet should fully dissolve in brew basket 116 so that there is nothing that needs to be removed from brew basket 116, as would be the case if a “tea bag like” cleaner bag were used. In that case, the bag would need to be removed from brew basket 116 after the cleaning aid in the bag has been dissolved.

Before master controller 132 causes apparatus 100 to run hot water over the cleaning tablet in brew basket 116, the tea concentrate present in each of storage receptacles 120 is vacated from storage receptacles 120. Master controller 132 causes a drain valve 152 in storage receptacle 120 to open and the tea concentrate present in storage receptacle 120 is drained by gravity into reservoir 144. Two of storage receptacles 120 can be vacated simultaneously. Self-clean pump 146 pumps the tea concentrate from reservoir 144 to a drain 150 of apparatus 100.

When the tea concentrate is vacated from storage receptacle 120 into reservoir 144, master controller 132 causes pump 134 corresponding to storage receptacle 120 to engage, thereby moving air through the line (e.g., tubing) that runs from storage receptacle 120 to delivery nozzle 106, which clears any tea concentrate that is present in that line.

Hot water from hot water tank 112 then runs over the cleaning tablet in brew basket 116 to dissolve the cleaning tablet and thereby produce a cleaning solution. This cleaning solution exits brew basket 116 through exit nozzle 122 and proceeds to storage receptacle 120 through heat exchanger 124 and fluid diverter 126, as if tea were being brewed. However, during the self-cleaning process, the heat exchange functionality of heat exchanger 124 is not engaged. For instance, if heat exchanger 124 is implemented using a counter-flow heat exchanger, tap water is not flowing in the opposite direction of the hot cleaning solution, unlike during the tea brewing process, because the cleaning solution functions best when it is hotter.

Once the cleaning solution is in storage receptacle 120, it remains there for about three to nine minutes, after which time master controller 132 causes a drain valve 152 in storage receptacle 120 to open, thereby draining the cleaning solution from storage receptacle 120 into reservoir 144. When the cleaning solution has drained into reservoir 144, the self-clean pump 146 recirculates the cleaning solution between reservoir 144 and storage receptacle 120 through a valve in self-clean manifold 148. The recirculated cleaning solution enters storage receptacle 120 through a dedicated cleaning nozzle 154 that is in fluid communication with the valve in self-clean manifold 148. In a presently preferred embodiment, dedicated cleaning nozzle 154 is a spray nozzle and the cleaning solution is sprayed into storage receptacle 120 for a predetermined period of time. After being sprayed into storage receptacle 120, the cleaning solution returns to reservoir 144 through drain valve 152 in storage receptacle 120. This recirculation of the cleaning solution between storage receptacle 120 and reservoir 144 is performed for a predetermined period of time.

The cleaning solution from two of storage receptacles 120 is drained into reservoir 144 simultaneously. The cleaning solution is then recirculated between reservoir 144 and one of storage receptacles 120 for a predetermined period of time, for example, 15 seconds. Next, the cleaning solution is recirculated between the reservoir 144 and the other one of storage receptacles 120 for the same predetermined period of time (e.g., 15 seconds). The recirculation of the cleaning solution from reservoir 144 then alternates between each of two storage receptacles 120 in the manner described above for a predetermined period of time. In a preferred embodiment, the recirculation of the cleaning solution from reservoir 144 alternates between each of the two storage receptacles 120 for a period of about nine minutes. At the completion of the recirculation process for each storage receptacle 120, the cleaning solution from each storage receptacle 120 is drained through drain valve 152 to reservoir 144 and self-clean pump 146 pumps the contents of reservoir 144 to drain 150 of apparatus 100.

A portion of the cleaning solution held in storage receptacle 120 is pumped from storage receptacle 120 by its corresponding pump 134 through the line (e.g., tubing) that runs from the storage receptacle 120 to the tea serving manifold 136 and the line (e.g., tubing) that runs from the tea serving manifold 136 to delivery nozzle 106, thereby cleaning those lines. The cleaning solution is pumped from storage receptacle 120 to delivery nozzle 106, through tea serving manifold 136, after the cleaning solution is brewed into storage receptacle 120 but before or during the recirculation of the cleaning solution between reservoir 144 and storage receptacle 120.

After the recirculation process has been completed for each storage receptacle 120 as described above, storage receptacle 120 is rinsed with hot water. In a presently preferred embodiment, master controller 132 causes second hot water tank 138 to supply hot water to reservoir 144 and self-clean pump 146 pumps the hot water to dedicated cleaning nozzle 154 of storage receptacle 120 through a valve of self-clean manifold 148. The hot water is sprayed into storage receptacle 120 to rinse it with hot water. A portion of the hot water from storage receptacle 120 is also pumped from storage receptacle 120 by its corresponding pump 134 through the line (e.g., tubing) that runs from storage receptacle 120 to tea serving manifold 136 and the line (e.g., tubing) that runs from tea serving manifold 136 to delivery nozzle 106, thereby rinsing those lines with hot water.

After each storage receptacle 120 has been rinsed with hot water, it is finally rinsed with tap water. In a presently preferred embodiment, master controller 132 causes tap water manifold 140 to supply tap water to reservoir 144 and self-clean pump 146 pumps the tap water to dedicated cleaning nozzle 154 of storage receptacle 120 through a valve of self-clean manifold 148. The tap water is sprayed into storage receptacle 120 to rinse it with tap water. A portion of the tap water from storage receptacle 120 is also pumped from the storage receptacle 120 by its corresponding pump 134 through the line (e.g., tubing) that runs from the storage receptacle 120 to the tea serving manifold 136 and the line (e.g., tubing) that runs from tea serving manifold 136 to delivery nozzle 106, thereby rinsing those lines with tap water.

Master controller 132 can be programmed to cause self-cleaning system 142 to recirculate the cleaning solution between reservoir 144 and storage receptacles 120 in any predetermined sequence. In addition, as described above, the cleaning solution from two of storage receptacles 120 is drained into reservoir 144 simultaneously and the recirculation of the cleaning solution from reservoir 144 then alternates between two storage receptacles 120. Any two of storage receptacles 120 can be grouped together for this purpose.

As has been described, the present invention provides an apparatus for preparing brewed beverages on demand.

While the invention has been particularly shown and described with reference to a preferred embodiment, it will be understood by those skilled in the art that various changes in form and detail may be made therein without departing from the spirit and scope of the invention.

What is claimed is:

1. An apparatus for preparing brewed beverages on demand, said apparatus comprising:
a touch screen for receiving a specific beverage order from a user;
a refrigerator;
a plurality of storage receptacles for storing various beverage concentrates, wherein said storage receptacles are located within said refrigerator to keep said various beverage concentrates cool in order to reduce microbial growth;
a plurality of pumps and tubing connecting to said storage receptacles;
a controller for activating one of said pumps to draw a beverage concentrate stored within one of said storage receptacles, with said beverage concentrate corresponding to said specific beverage order;
a tea-serving manifold, connecting to said pumps and tubing, for mixing said beverage concentrate from said one storage receptacle with an appropriate amount of water to generate a specific beverage to fulfill said specific beverage order; and
a delivery nozzle for dispensing said specific beverage.

2. The apparatus from claim 1, further comprising a plurality of brew baskets for receiving beverage bags to produce said various beverage concentrates at a first temperature.

3. The apparatus from claim 2, further comprising a heat exchanger for cooling said various beverage concentrates to a second temperature lower than said first temperature.

4. The apparatus from claim 2, further comprising a first hot water tank to supply hot water to said brew baskets.

5. The apparatus from claim 4, further comprising a second hot water tank for mixing with said beverage concentrate from said one storage receptacle.

6. The apparatus from claim 1, wherein said tea-serving manifold further mixes a sweetener and/or flavorings with said beverage concentrate.

7. The apparatus of claim 1, wherein one of said storage receptacles includes a level sensor to detect whether beverage concentrate held in said storage receptacles drops below a predetermined level.

8. The apparatus of claim 1, wherein one of said storage receptacles includes a motor and a stirrer for stirring beverage concentrate periodically while it is being held in said one storage receptacle.

9. The apparatus of claim 1, further comprising a self-cleaning system having a reservoir, a self-clean pump, and a self-clean manifold.

10. The apparatus of claim 9, wherein a self-cleaning cycle is activated by using a Clean option on said touch screen.

11. An apparatus for preparing brewed beverages on demand, said apparatus comprising:
at least one brew basket for receiving a beverage bag and hot water to produce a beverage concentrate at a first temperature;
a heat exchanger for cooling said beverage concentrate to a second temperature lower than said first temperature;
at least one storage receptacle for receiving said beverage concentrate from said heat exchanger, wherein said beverage concentrate is further cooled down to a third temperature lower than said second temperature when said beverage concentrate is being held in said at least one storage receptacle;
a touch screen for receiving a specific beverage order from a user;
a tea-serving manifold, in response to the receipt of said specific beverage order from said user via said touch screen, for combining said beverage concentrate from said at least one storage receptacle and hot water to generate a specific beverage to fulfill said specific beverage order; and
a delivery nozzle for dispensing said specific beverage.

12. The apparatus of claim 11, further comprising a refrigerator for storing said at least one storage receptacle to cool said beverage concentrate contained within said at least one storage receptacle to said third temperature.

13. The apparatus of claim 11, further comprising a first hot water tank to supply said hot water to said at least one brew basket.

14. The apparatus of claim 13, further comprising a second hot water tank to provide said hot water to combine with said beverage concentrate from said at least one storage receptacle.

15. The apparatus of claim 13, further comprising a tap water manifold to provide tap water to combine with said beverage concentrate from said at least one storage receptacle.

16. The apparatus of claim 11, wherein said tea-serving manifold further combines a sweetener and/or flavorings with said beverage concentrate from said at least one storage receptacle.

17. The apparatus of claim 11, wherein said at least one storage receptacle includes a level sensor to detect whether said beverage concentrate held in said at least one storage receptacle drops below a predetermined level.

18. The apparatus of claim 17, wherein said sensor includes a load cell, a resistive probe, an optical sensor, or a float switch.

19. The apparatus of claim 11, wherein said at least one storage receptacle includes a motor and a stirrer for stirring said beverage concentrate periodically while it is being held within said at least one storage receptacle.
